(19) United States
(12) Patent Application Publication
(10) Pub. No.: US 2011/0126238 A1
(43) Pub. Date: May 26, 2011

(54) Program information distribution apparatus, program information distribution method, program and program information distribution system

(75) Inventor: Koichi Ogasawara, Tokyo (JP)

(73) Assignee: Sony Corporation, Tokyo (JP)

(21) Appl. No.: 12/925,585

(22) Filed: Oct. 25, 2010

(30) Foreign Application Priority Data
Nov. 20, 2009 (JP) P2009-265393

(51) Int. Cl. H04N 5/445

(52) U.S. Cl. 725/46

(57) ABSTRACT

There is provided a program information distribution system including a character information receiving unit receiving desired character information as a predetermined transmitting destination from a program receiving apparatus having a character information transmitting unit transmitting the desired character information regarding a program desired to be received, a program information receiving unit receiving scheduled program information as a predetermined transmitting destination from a program distributing apparatus having a program information transmitting unit transmitting the scheduled program information regarding a program scheduled to be distributed in a certain time slot, a matching processing unit determining whether the scheduled program information includes the desired character information by comparison between the desired character information and the scheduled program information, and a program information transferring unit transferring the scheduled program information including the desired character information to the program receiving apparatus if determined that the scheduled program information includes the desired character information.

### BACKGROUND OF THE INVENTION

1. Field of the Invention

The present invention relates to a program information distribution apparatus, a program information distribution method, a program and a program information distribution system.

2. Description of the Related Art

Broadcasting stations broadcast predetermined broadcasting programs in a certain time slot. In consequence, each broadcasting station creates own program listings indicating what kind of program is to be broadcasted in which time slot. Previously, a program information providing server has provided program information (such as EPG, ECG) based on the program listings of broadcasting stations, and a receiving apparatus for receiving a broadcasting has received the program information such as a program guide. The receiving apparatus is a video recorder, a television set, or the like, which a viewer uses. At this time, the receiving apparatus has obtained the program information at a predetermined time interval from the program information providing server to update the program information that has been stored (the Pull method).

Whereas there is disclosed a technology in which a server connected to a network accumulates not program information such as a program guide but its program content itself to and redistributes the accumulated program contents to users. For example, WO 2005-112452 disclosed a technology to accumulate non-accumulated program contents in order to search and distribute the latest program contents currently being broadcasted or right after broadcasted, a specific scene or a specific media in programs. Moreover, Japanese Unexamined Patent Application Publication No. 2003-101498 disclosed a technology to accumulate distributed program contents to redistribute. Further, Japanese Unexamined Patent Application Publication No. 2005-267577 disclosed a technology in which key information related to content a user is interested in is transmitted to a server, and in which the server provides information indicating where the content is stored based on the key information to the user.

### SUMMARY OF THE INVENTION

In a case where there are a lot of distributors on a network, the distributors who distribute a prescribed program at a certain time slot, there is assumed a method of using the network in which a content transmitting/receiving system allows a viewer to view the program at the time when a certain distributor distributes the program. A program that a distributor distributes is, for example, music in a live relay, shopping information of a supermarket in a certain area, or the like. In such a system in which each of a lot of distributors distributes a program in real time, there is a possibility of lack of its real time capability in a method which a receiving apparatus on the viewer side regularly obtains program information from the program information providing server.

In other words, in an existing broadcasting system, a broadcasting station has been an enterprise or an entity, an organizing of programs has been managed by the broadcasting station, and the programs have been broadcasted. On the contrary, different from the existing broadcasting system, the above content transmitting/receiving system allows unspecified ordinary users to use a distribution apparatus to distribute, in real time, each own program in a time slot that each of them has decided on their own. In the past, the program information was created based on the program listings provided by broadcasting stations on the assumption that programs are to be broadcasted as scheduled.

However, in the above content transmitting/receiving system, it is assumed that a distributor suddenly would start or discontinue distribution of programs. Therefore, in a system where a lot of distributors distribute programs respectively, it is difficult that the program information distribution server obtains all the program listings of all distributors beforehand, as in the past, to generate or manage the program information.

In light of the foregoing, it is desirable to provide a program information distribution apparatus, a program information distribution method, a program and a program information distribution system, which are novel and improved, and which are capable of providing, in real time, program information capable of changes to a receiving apparatus when a program listing distributed by a program distributor is to be changed.

According to an embodiment of the present invention, there is provided a program information distribution apparatus including a character information receiving unit for receiving desired character information as a predetermined transmitting destination from a program receiving apparatus having a character information transmitting unit that transmits the desired character information related to a program desired to be received, a program information receiving unit for receiving scheduled program information as a predetermined transmitting destination from a program distributing apparatus having a program information transmitting unit that transmits the scheduled program information related to a program scheduled to be distributed in a certain time slot, a matching processing unit for determining whether the scheduled program information includes the desired character information by comparison between the desired character information and the scheduled program information, and a program information transferring unit for transferring the scheduled program information including the desired character information to the program receiving apparatus if determined that the desired character information is included in the scheduled program information.

The program information distribution apparatus may further include a first connection destination information storage unit for holding first connection destination information that identifies the program receiving apparatus. The program information transmitting unit may transmit the scheduled program information to the program receiving apparatus based on the first connection destination information.

The program information distribution apparatus may further include a program information storage unit for holding the scheduled program information including information related to distribution time of the program, a second connection destination information storage unit for holding second connection destination information that identifies the program distributing apparatus, and a distribution state checking unit for confirming whether the program has been distributed from the program distributing apparatus in the distribution time of the program based on the second connection destination information.

If confirmed that the program has not been distributed from the program distributing apparatus in the distribution time, the program information transmitting unit may transmit a notification indicating that the scheduled program information is invalid to the program receiving apparatus based on the first connection destination information.

If confirmed that the program has not been distributed from the program distributing apparatus in the distribution time, the program information storage unit may delete the scheduled program information that is held.

The distribution state checking unit may confirm a content of the program distributed from the program distributing apparatus in the distribution time. The distribution state checking unit may request the program distributing apparatus to cancel the distribution of the program in accordance with the content of the program.

The program information distribution apparatus may further include the program information storage unit that holds the scheduled program information. The matching processing unit may determine whether the scheduled program information includes the desired character information by comparison between the desired character information and the scheduled program information that is stored. The program information transferring unit may transfer the scheduled program information including the desired character information to the program receiving apparatus if determined that the desired character information is included in the scheduled program information that is stored.

According to another embodiment of the present invention, there is provided a program information distribution method including the steps of receiving, by a character information receiving unit, desired character information as a predetermined transmitting destination from a program receiving apparatus having a character information transmitting unit that transmits the desired character information related to a program desired to be received, receiving, by a program information receiving unit, scheduled program information as a predetermined transmitting destination from a program distributing apparatus having a program information transmitting unit that transmits the scheduled program information related to a program scheduled to be distributed in a certain time slot, determining, by a matching processing unit, whether the scheduled program information includes the desired character information by comparison between the desired character information and the scheduled program information, and transferring, by a program information transferring unit, the scheduled program information including the desired character information to the program receiving apparatus if determined that the desired character information is included in the scheduled program information.

According to another embodiment of the present invention, there is provided a program causing a computer to function as a receiving unit for receiving desired character information as a predetermined transmitting destination from a program receiving apparatus having a character information transmitting unit that transmits the desired character information related to a program desired to be received, a receiving unit for receiving scheduled program information as a predetermined transmitting destination from a program distributing apparatus having a program information transmitting unit that transmits the scheduled program information related to a program scheduled to be distributed in a certain time slot, a determining unit for determining whether the scheduled program information includes the desired character information by comparison between the desired character information and the scheduled program information, and a transferring unit for transferring the scheduled program information including the desired character information to the program receiving apparatus if determined that the desired character information is included in the scheduled program information.

According to another embodiment of the present invention, there is provided a program information distribution system including a program receiving apparatus having a character information transmitting unit that transmits desired character information related to a program desired to be received to a predetermined transmitting destination, a program distributing apparatus having a program information transmitting unit that transmits scheduled program information related to a program scheduled to be distributed in a certain time slot to a predetermined transmitting destination, and a program information distribution apparatus including a character information receiving unit for receiving the desired character information as the predetermined transmitting destination from the program receiving apparatus, a program information receiving unit for receiving the scheduled program information as the predetermined transmitting destination from the program distributing apparatus, a matching processing unit for determining whether the scheduled program information includes the desired character information by comparison between the desired character information and the scheduled program information, and a program information transferring unit for transferring the scheduled program information including the desired character information to the program receiving apparatus if determined that the desired character information is included in the scheduled program information.

According to the embodiments of the present invention described above, it is possible to provide, in real time, program information that has responded to a change to a receiving apparatus when a program listing of a program which will be distributed by a program distributor is to be changed.

### BRIEF DESCRIPTION OF THE DRAWINGS

FIG. 1 is a block diagram for illustrating a configuration of a program information distribution system according to one embodiment of the present invention;

FIG. 2 is a block diagram for illustrating a program information distribution server according to the present embodiment;

FIG. 3 is a flow chart for illustrating an operation related to program information distribution of the program information distribution system according to the present embodiment;

FIG. 4 is a flow chart for illustrating an operation related to program information distribution of the program information distribution system according to the present embodiment;

FIG. 5 is a flow chart for illustrating an operation in which the program information distribution system according to the present embodiment confirms a state of program distribution;

FIG. 6 is a flow chart for illustrating an operation in which the program information distribution system according to the present embodiment confirms a state of program distribution;

FIG. 7 is a flow chart for illustrating an operation in which the program information distribution system according to the present embodiment confirms a state of program distribution;

FIG. 8 is an explanatory diagram for illustrating an example of program information that is transmitted from the distributor side and that is used for a matching process;

FIG. 9 is an explanatory diagram for illustrating an example of keyword for matching that is transmitted from the receiving side and that is used for a matching process;

FIG. 10 is a flow chart for illustrating a matching process operation of the program information distribution server 100 according to the present embodiment;

FIG. 11 is an explanatory diagram for illustrating an example of data to be stored in a cache processing unit of the program information distribution server 100 according to the present embodiment;

FIG. 12 is an explanatory diagram for illustrating transition of an area specifying screen in a video receiving apparatus 300 according to the present embodiment; and

FIG. 13 is an explanatory diagram for illustrating an example of program information to be displayed in the video receiving apparatus 300 according to the present embodiment.

### DETAILED DESCRIPTION OF THE EMBODIMENT(S)

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Explanations will be described hereinafter in the following order:

1. Configuration of one embodiment

2. Operation of one embodiment

### 1. Configuration of One Embodiment

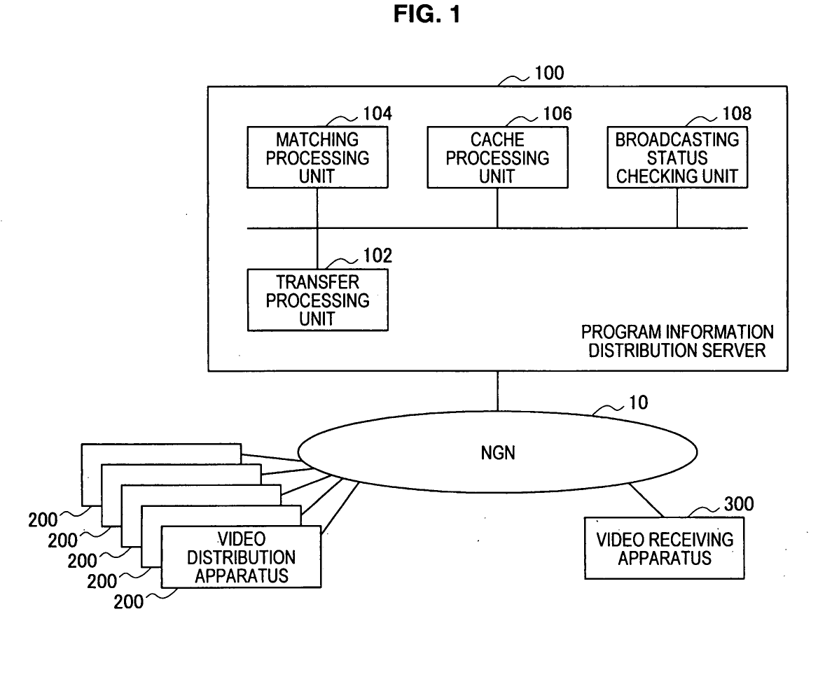

At first, an explanation will be given on a program information distribution system according to the first embodiment of the present invention. The program information distribution system consists of a network such as Next Generation Network (NGN) 10, or the like. The program information distribution system includes, as shown in FIG. 1 for example, a program information distribution server 100, a plurality of video distribution apparatuses 200, and a video receiving apparatus 300 or the like. FIG. 1 is a block diagram for illustrating a configuration of a program information distribution system according to the present embodiment. The NGN 10 is connected with a DNS server, which is not shown, for name resolution of the other communicating party.

The program information distribution system is applied to a content transmitting/receiving system in which there are a lot of distributors on the NGN 10, the distributors who distribute a prescribed program at a certain time slot, and a viewer is to view the program at the time when a certain distributor distributes the program. Especially, this content transmitting/receiving system is a system allows unspecified distributors (ordinary users are assumed) to use the video distribution apparatuses 200 to distribute, in real time, each own program in a time slot that each of them has decided on their own. A viewer receives a program by the video receiving apparatus 300, and views it. A program that a distributor distributes is, for example, music in a live relay, a relay of shopping information of a supermarket in a certain area, local news, weather forecast, or events in a company or a school or the like.

The program information is information related to a program that the distributor distributes, such as a distributor's name, a program name, distributing time slot, outline of a program, or the like. In the content transmitting/receiving system, a viewer may receive the program information directly from the distributor of the program. However, in a system in which each of a lot of distributors distributes programs in real time, there is a possibility of lack of its real time capability in a method which a receiving apparatus on the viewer side regularly obtains program information from the program information providing server. On the contrary, according to the program information distribution system of the present embodiment, it is possible to provide, in real time, program information that has responded to a change to the video receiving apparatus 300 even when a program listing of the program distributed by the distributor is to be changed due to an incident such as a case where the distributor suddenly started or discontinued distribution of program.

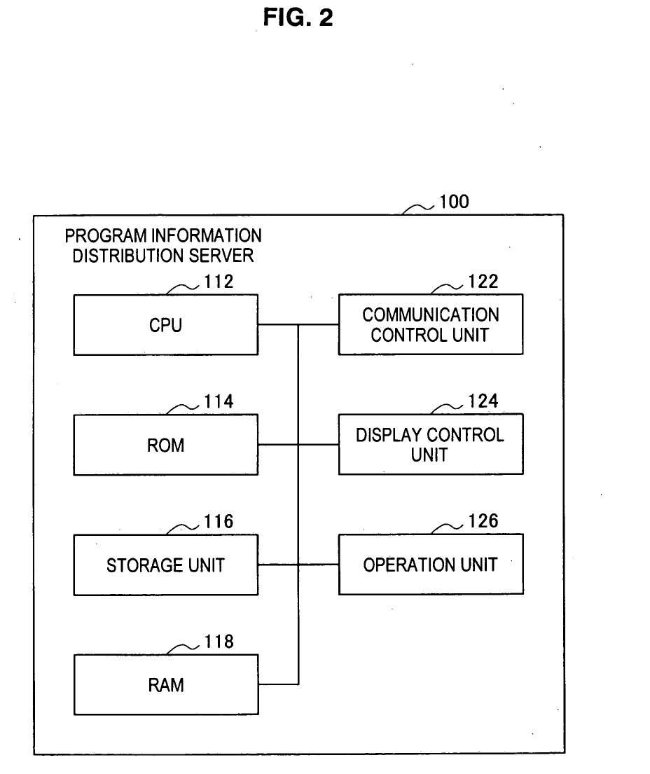

The program information distribution server 100 is an information processing apparatus as shown in FIG. 2, and includes a CPU 112, a ROM 114, a storage unit 116, a RAM 118, a communication control unit 122, a display control unit 124, an operation unit 126, or the like. FIG. 2 is a block diagram for illustrating a program information distribution server according to the present embodiment. The program information distribution server 100 receives program information from a plurality of the video distribution apparatuses 200, and transmits the program information including information that a viewer expects to the video receiving apparatus 300. The program information distribution server 100 is an example of a program information distribution apparatus.

The CPU (Central Processing Unit) 112 functions as an arithmetic processing unit or a control unit, and executes a program recorded on a memory of the ROM 114, or the like. The CPU 112 of the present embodiment includes, for example, a later-described matching processing unit 104, a broadcasting status checking unit 108, or the like.

The ROM (Read-Only Memory) 114 is a read-only memory, and records a program or the like that is executed by the CPU 112. The CPU 112 reads the program recorded in ROM 114.

The storage unit 116 is a device to store various data, such as a hard disk drive, or the like. The RAM (Random Access Memory) 118 temporally stores program information or the like. The RAM 118 corresponds to a later-described cache processing unit 106.

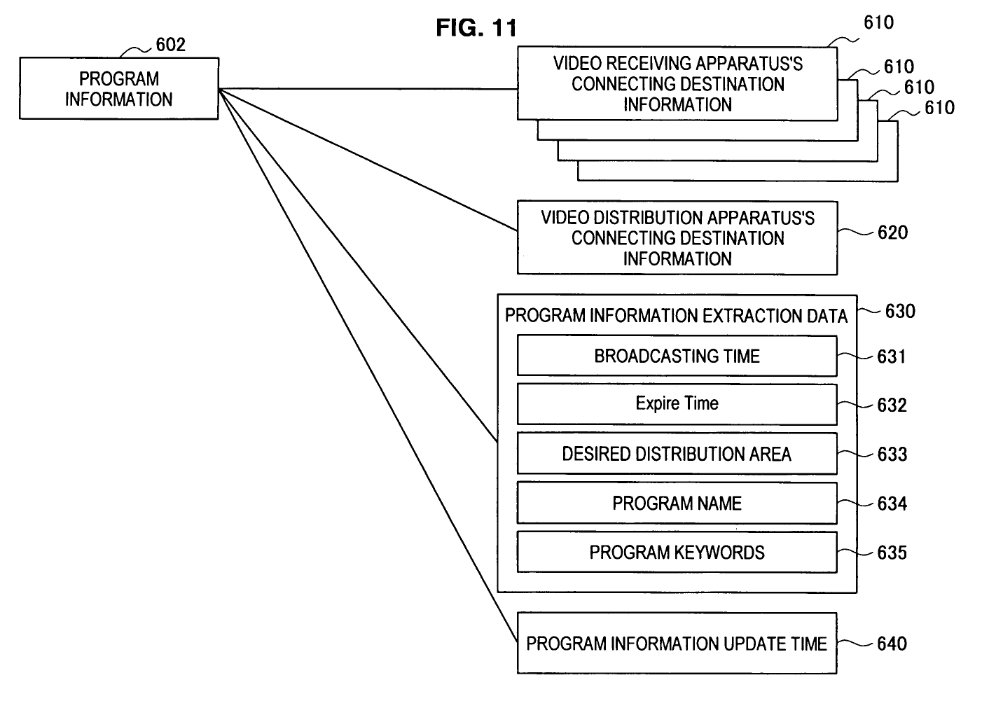

FIG. 11 is an explanatory diagram for illustrating an example of data to be stored in the cache processing unit 106 of the program information distribution server 100 according to the present embodiment. The cache processing unit 106 stores program information 602 as described later. The program information 602 is to be stored in association with connection destination information 610 of the video receiving apparatus 300 and connection destination information 620 of the video distribution apparatus 200. Moreover, program information extraction data 630 is included in the program information 602, and to be used for a matching process. The program information extraction data 630 is, for example, broadcasting time of a program 631, Expire Time 632 indicating time when the program information becomes invalid, a desired distribution area 634, a program name 634, and program keywords 635, or the like. The program information 602 is related to program information update time that indicates an interval to update the program information.

A communication control unit 122 controls data transmission by wire or wirelessly. The communication control unit 122 connects to the NGN 10, for example, and transmits/receives data to/from the video distribution apparatus 200 and the video receiving apparatus 300. The communication control unit 122 corresponds to a later-described transfer processing unit 102.

A display control unit 124 transmits display data to a display device such as a display that is connected to the program information distribution server 100. For example, the display control unit 124 transmits necessary data for management of the program information distribution server 100 to the display device, as a result, an administrator can manage the program information distribution server 100 via the display device. The operation unit 126 is, for example, a keyboard, a mouse, a touch panel, or the like, and transmits an operational signal to the CPU 112 after accepting an operation of the administrator.

The video distribution apparatus 200 is an information processing apparatus for distributing contents like movies to the viewers. The content that the video distribution apparatus 200 distributes is, for example, a program that has been determined in advance to be distributed in real time in a certain time slot. Note that the content to be distributed by the video distribution apparatus 200 is not limited to a movie, but may be data consisting of movie and audio, or data consisting of audio only. The content that the video distribution apparatus 200 distributes is not limited to a distribution in real time, but may distribute, in real time, data which has been recorded in advance, in a certain time slot.

The video distribution apparatus 200 transmits the scheduled program information regarding programs scheduled to be distributed in a certain time slot to the program information distribution server 100, in the present embodiment. The video distribution apparatus 200 is an example of a program distributing apparatus.

The video receiving apparatus 300 is an information processing apparatus on the side of a viewer who receives contents such as movie or the like from the video distribution apparatus 200. The video receiving apparatus 300 transmits desired character information related to a program that the viewer would like to receive, to the program information distribution server 100. Further, the video receiving apparatus 300 receives the scheduled program information including the desired character information that has been transmitted in advance, from the program information distribution server 100. The video receiving apparatus 300 is an example of a program receiving apparatus.

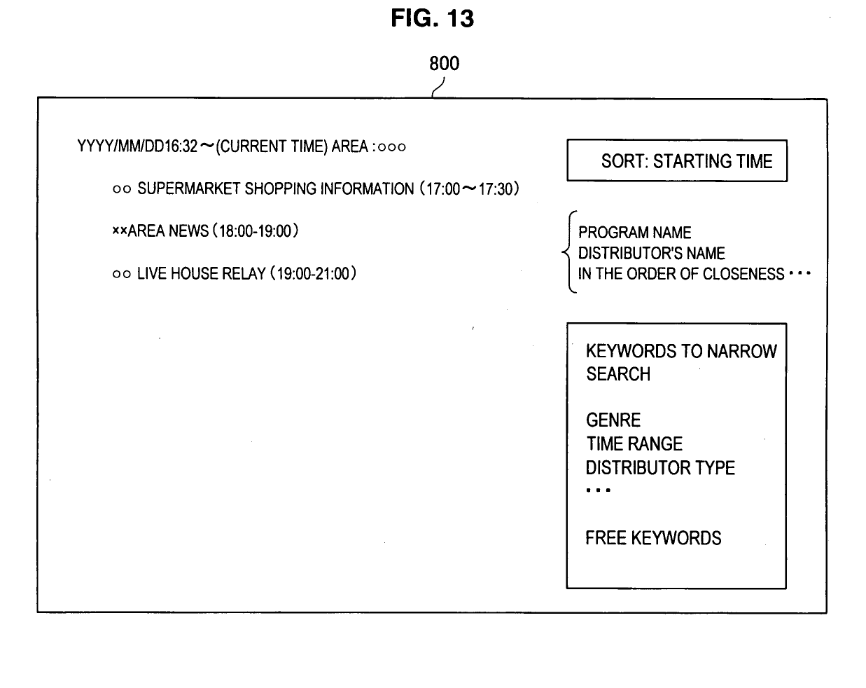

Subsequently, the video receiving apparatus 300 displays the received scheduled program information on a display apparatus. FIG. 13 is an explanatory diagram for illustrating an example of program information to be displayed in the video receiving apparatus 300 according to the embodiment. A screen 800 displays a list of multiple programs, the current date and time, an area that is receiving, conditions the user specified, and the like. The conditions the user specified are, for example, keywords for narrowing data, genre of program, time range for distribution, distributor's type, and the like. Programs to be displayed may be sorted in the order of start time, name of time, name of distributor, distance from the video receiving apparatus 300, or the like.

### 2. Operation of One Embodiment

Next, an explanation will be given on an operation regarding the program information distribution of the program information distribution system according to the present embodiment.

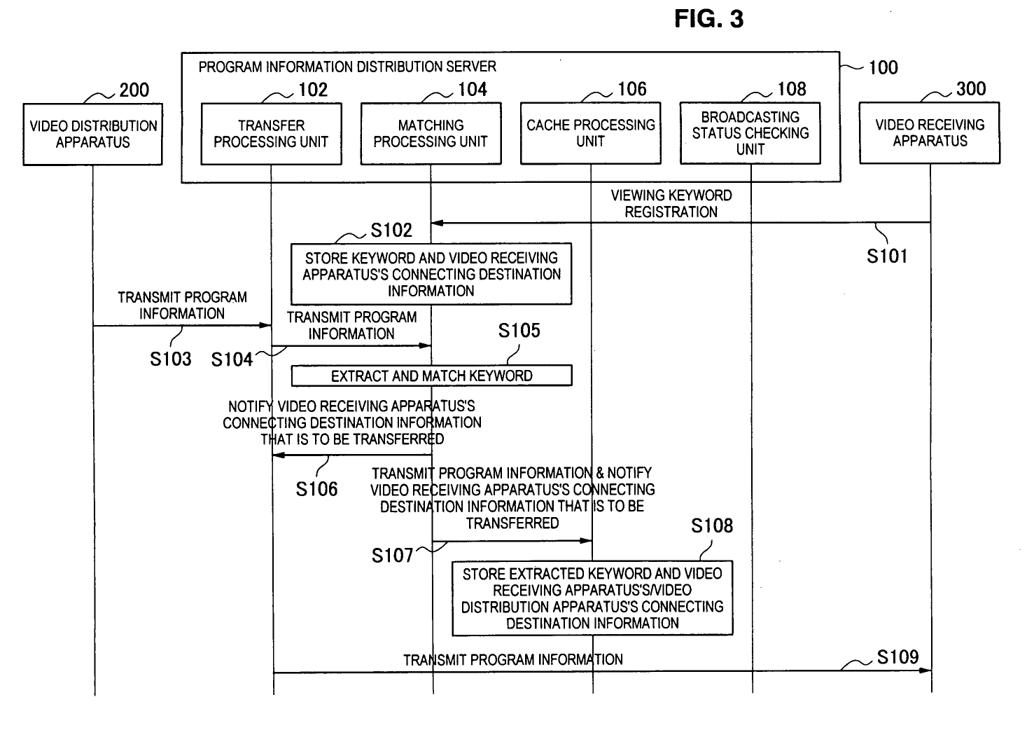

At first, the operation regarding the program information distribution of the program information distribution system according to the present embodiment will be explained. FIG. 3 is a flow chart for illustrating the operation related to program information distribution of the program information distribution system according to the embodiment. FIG. 3 shows a case where the video distribution apparatus 200 transmits program information to the program information distribution server 100, and the program information distribution server 100 transfers the program information to the video receiving apparatus 300.

According to the present embodiment, the program information is to be provided by the video distribution apparatus 200, and is to be provided in real time to the video receiving apparatus 300 on the viewer's side.

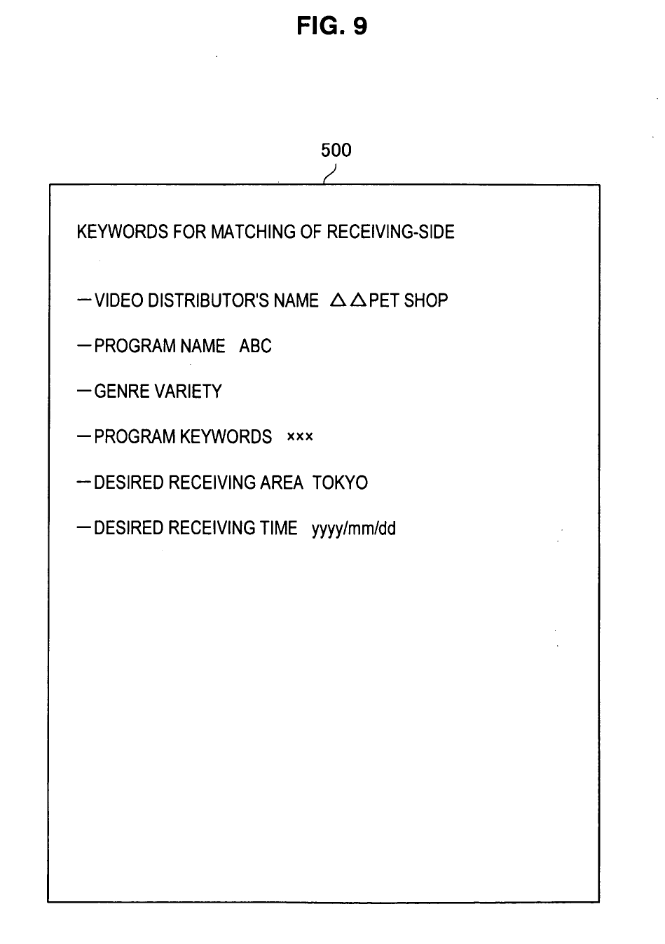

At first, keywords related to a program that a viewer desires to view (receive) is transmitted from the video receiving apparatus 300 to the matching processing unit 104 of the program information distribution server 100 (step S101). The matching processing unit 104 is an example of a character information receiving unit. Here, the keywords are transmitted from the receiving side and are used for a matching process. FIG. 9 shows an example of the keywords. FIG. 9 is an explanatory diagram for illustrating an example of keyword for matching that is transmitted from the receiving side and that is used for a matching process. The keywords are to be classified into, for example, items of distributor's name, program name, genre, program keyword, desired receiving area, desired receiving time, and the like. The keywords can be specified so that a program which meets a plurality of items of condition or a program which meets any one of the items of conditions of program is to be extracted.

Subsequently, the keywords transmitted from the video receiving apparatus 300 are stored in the matching processing unit 104 along with connection destination information of the video receiving apparatus 300 (step S102). Storing the connection destination information of the video receiving apparatus 300 enables the program information distribution server 100 to identify a transmission destination when transmitting program information later to the video receiving apparatus 300.

On the contrary, the video distribution apparatus 200 transmits, in real time, program information of a program which is scheduled to be distributed by the video distribution apparatus 200 itself to the program information distribution server 100 (step S103). At this time, using a MESSAGE request of SIP (Session Initiation Protocol), for example, the video distribution apparatus 200 describes a subject of the program information in a body part of data, and transmits the MESSAGE request including the program information to the program information distribution server 100.

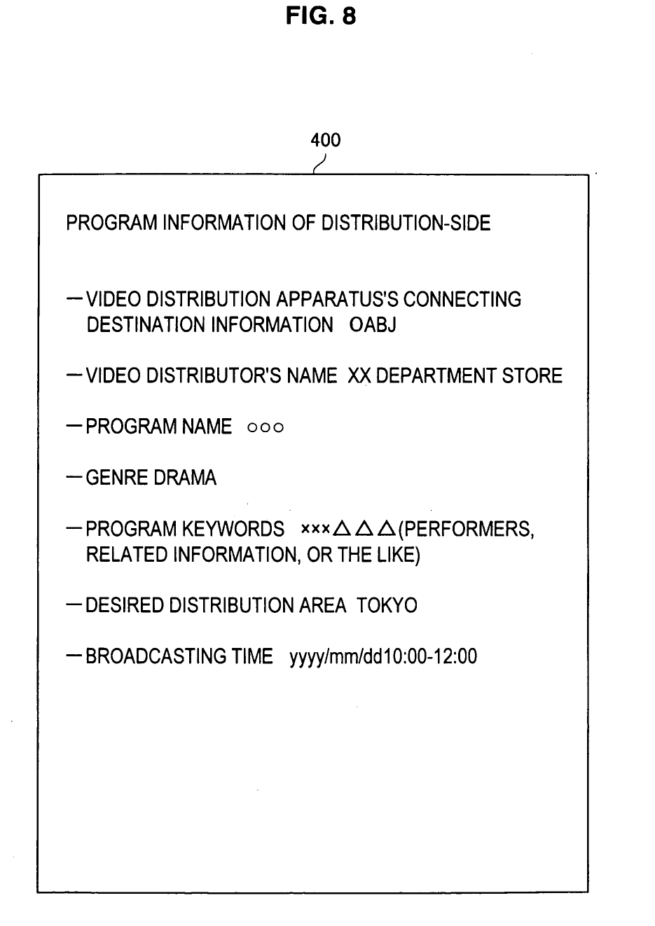

FIG. 8 is an explanatory diagram for illustrating an example of program information that is transmitted from the distributor side and that is used for a matching process. The program information is to be classified into, for example, items of connection destination information of the video distribution apparatus 200, name of a distributor of movie, program name, genre, program keywords, desired distribution area, broadcasting time (distribution time), and the like.

If the program information distribution server 100 newly receives program information, the transfer processing unit 102 transmits the program information to the matching processing unit 104 (step S104). The transfer processing unit 102 is an example of a program information transferring unit, and the matching processing unit 104 is an example of a program information receiving unit. Next, the matching processing unit 104 extracts a keyword related to genre, distributor's name and the like based on the program information included in the received MESSAGE request. Then, the matching processing unit 104 verifies a desired keyword related to the program desired to be received that has been received from the video receiving apparatus 300 and registered in advance, and determines whether the program information includes the desired keyword (step S105). Note that the determination on whether the program information includes the desired keyword is not limited to a perfect matching, but may include a case of being conceptually resemble.

When the program information includes the desired keyword, the MESSAGE request including the program information is to be transferred to the video receiving apparatus 300 that has transmitted the desired keyword. Specifically, the matching processing unit 104 notifies the transfer processing unit 102 of connection destination information related to the video receiving apparatus 300 which is the destination to where the program information is transferred (step S106). Then, the transfer processing unit 102 transfers the program information received from the video distribution apparatus 200 in step S103 to the video receiving apparatus 300 (step S109).

The processing operations describe above makes the video receiving apparatus 300 to update and display the content of the program information on a basis of the notification from the program information distribution server 100. As a result, the viewer can refer to the provided program information in real time.

Note that the matching processing unit 104 notifies the cache processing unit 106 of program information, and of connection destination information related to the video receiving apparatus 300 that is to where the program information is transferred (step S107). The cache processing unit 106 stores the extracted keyword, the connection destination information of the video receiving apparatus 300 and the video distribution apparatus 200 (step S108). This enables the program information distribution server 100 to use the stored data for a sequence for confirming broadcasting status of the video distribution apparatus 200, as described later.

Here, the program information distribution of the program information distribution system described using FIG. 3 is in a case where the program information is transmitted from the video distribution apparatus 200 to the program information distribution server 100, however, the present embodiment can be applied also to a case where the program information is not to be transmitted from the video distribution apparatus 200.

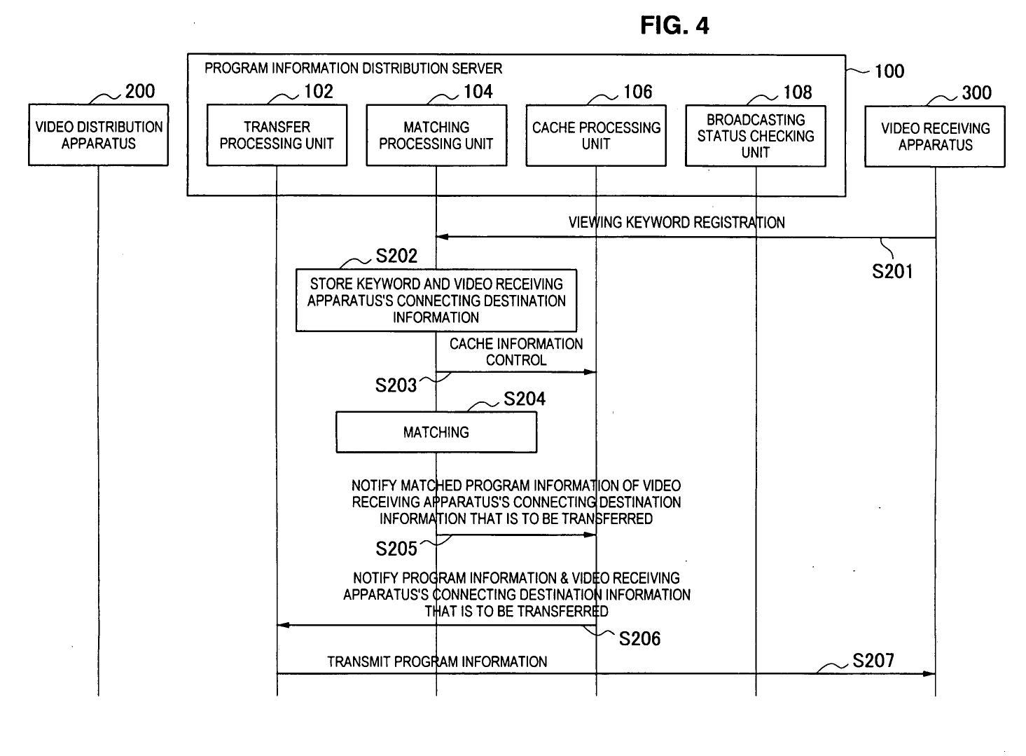

FIG. 4 is a flow chart for illustrating an operation related to program information distribution of the program information distribution system according to the present embodiment. FIG. 4 shows a case where the video distribution apparatus 200 does not transmit program information to the program information distribution server 100, but the program information distribution server 100 transmits the program information stored therein to the video receiving apparatus 300.

When the video receiving apparatus 300 transmits and registers a keyword related to a program desired to be received to the program information distribution server 100, the program information distribution server 100 performs a process of matching the program information stored therein. As a result of the matching process, if there is program information that includes the desired keyword, the program information distribution server 100 generates a MESSAGE request and transmits the MESSAGE request including the program information to the video receiving apparatus 300.

Specifically, at first, a keyword related to a program that the viewer desires to view (receive) is transmitted from the video receiving apparatus 300 to the matching processing unit 104 of the program information distribution server 100 (step S201). The, the keyword transmitted from the video receiving apparatus 300 is stored into the matching processing unit 104 along with connection destination information of the video receiving apparatus 300 (step S202).

Next, the matching processing unit 104 performs a cache information control to the cache processing unit 106 that stores program information (step S203). That is, the matching processing unit 104 reads the program information from the cache processing unit 106. Then, the matching processing unit 104 verifies a desired keyword related to the program desired to be received that has been received from the video receiving apparatus 300 and registered in advance, and determines whether the program information includes the desired keyword (step S204).

When the program information includes the desired keyword, the matching processing unit 104 notifies the matched program information, which is stored in the cache processing unit 106, of connection destination information related to the video receiving apparatus 300 which is the destination to where the program information is transferred (step S205). Subsequently, the cache processing unit 106 notifies the transfer processing unit 102 of the program information and of the connection destination information related to the video receiving apparatus 300 which is the destination to where the program information is transferred (step S206). Then, the transfer processing unit 102 transfers the program information received from the cache processing unit 106 in step S206 to the video receiving apparatus 300 (step S207).

### [Matching Process]

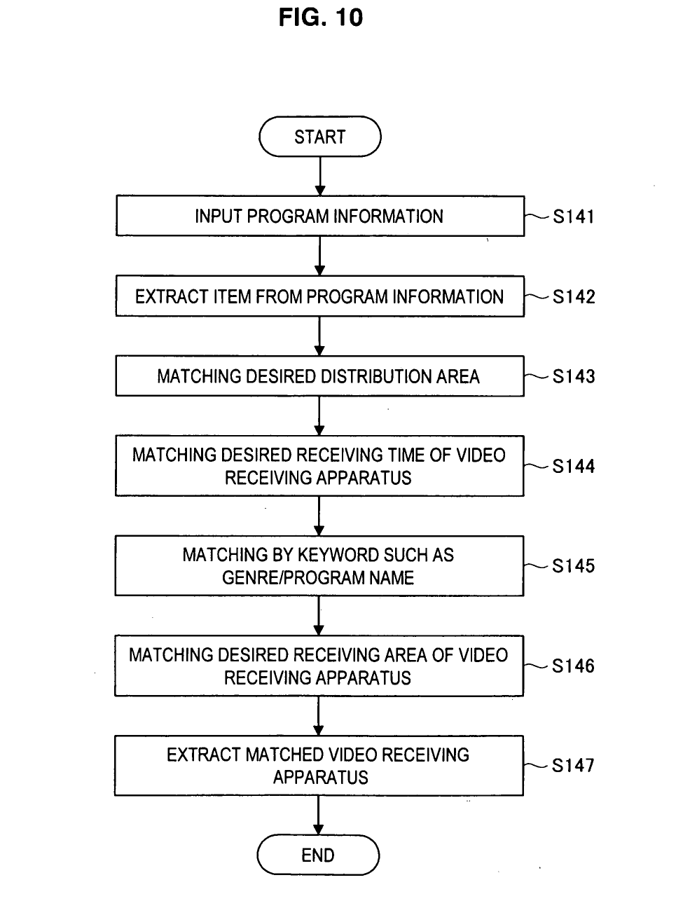

Next, referring to FIG. 10, a matching process of the program information distribution server 100 according to the present embodiment will be explained. FIG. 10 is a flow chart for illustrating the matching process operation of the program information distribution server 100 according to the present embodiment.

At first, program information is input into the matching processing unit 104 (step S141). The program information to be input may be, as described above, the one transmitted in real time from the video distribution apparatus 200, or may be the one that the program information distribution server 100 holds therein.

The matching processing unit 104 extracts each item of the program information from the program information data (step S142). The matching processing unit 104 performs matching of characters on each of extracted items. If the video distribution apparatus 200 specifies areas desired to be distributed with a program, the matching processing unit 104 performs matching on connection destination information of the video receiving apparatus 300 and desired distribution area of the video distribution apparatus 200. As a result, areas where the video receiving apparatus 300 can receive the program can be identified (step S143). This enables the program information distribution server 100 to provide the program information only to the limited areas.

If the video receiving apparatus 300 specifies desired time to receive a program, the matching processing unit 104 performs matching on desired time that is received from the receiving side and the time slot that the video distribution apparatus 200 distributes a program. As a result, the time when the video receiving apparatus 300 receives a program can be identified (step S144). Moreover, if the video receiving apparatus 300 specifies keywords such as desired genre, program name and the like with respect of receiving a program, the matching processing unit 104 performs matching on the desired keyword received from the receiving side and the program information of the program that the video distribution apparatus 200 distributes. As a result, the program that the video receiving apparatus 300 desires to receive can be identified (step S145).

Further, if the video receiving apparatus 300 specifies the areas to where the video distribution apparatus 200 are distributing a program as a keyword, the matching processing unit 104 performs matching on the connection destination information of the video distribution apparatus 200 and the keyword (area) that the video receiving apparatus 300 specifies. As a result, the video receiving apparatus 300 can obtain program information within the area specified (step S146). As for a case where a viewer specifies an area, it is assumed that the viewer has a purpose of collecting information on the viewer's neighborhood or travel destination, fixed-point observation, and the like.

Through all or a part of the above steps from S143 to S146, the program information distribution server 100 extracts the video receiving apparatus 300 to which transfers or transmits program information (step S147). Since it is expected to gradually decrease the volume of information by processing the steps in the order of from S143 to S146, the processing speed will be improved. Note that the processing may be performed in the order other than from S143 to S146.

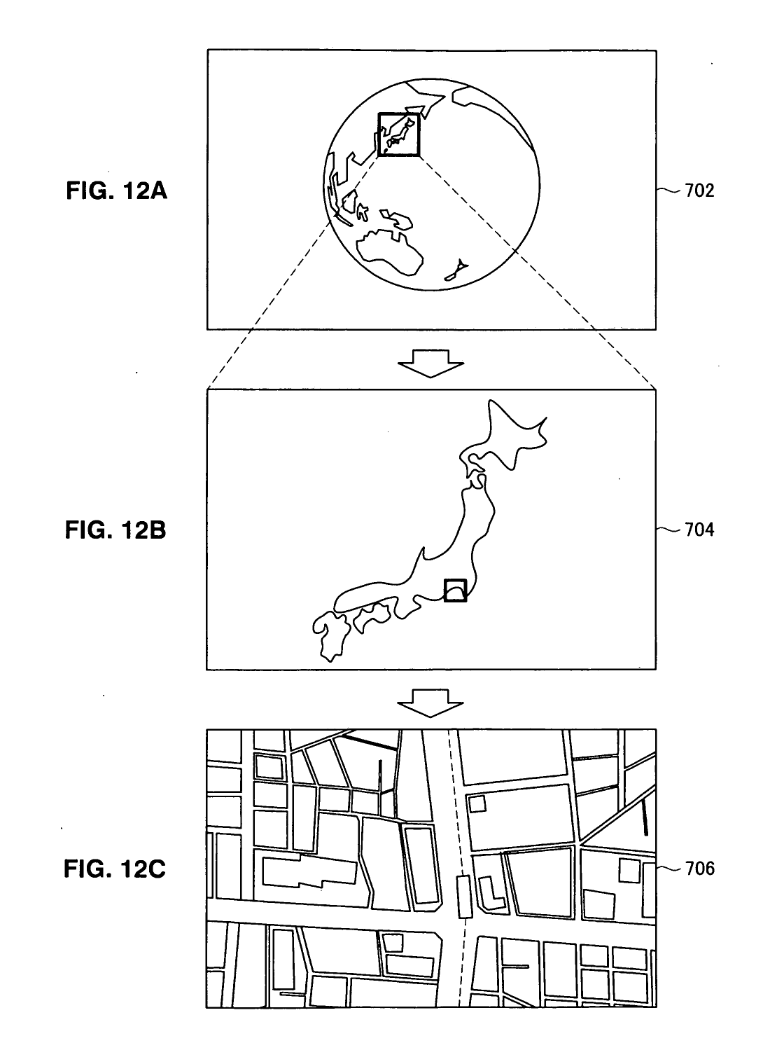

Note that when the video distribution apparatus 200 registers a desired distribution area in step S143, or when the video receiving apparatus 300 registers a desired receiving area as a keyword in step S146, the areas may be selected from a map on a screen of a display apparatus. This makes it possible to provide a user interface which can perform selecting an area easily. FIG. 12 is an explanatory diagram for illustrating transition of an area specifying screen in the video receiving apparatus 300 according to the present embodiment. The display screen will transit in the order of a screen 702, a screen 704, and a screen 706, and it becomes easier for a user to specify not only a large area but also a local area.

### [Transfer Method]

Next, an explanation will be given on a method of transferring a MESSAGE request including program information.

When received a MESSAGE request from the video distribution apparatus 200, the transfer processing unit 102 copies a body part included in the MESSAGE request, and change values of From/To parameter in a Header part. That is, the transfer processing unit 102 changes a description of From/the video distribution apparatus 200/To:the program information distribution server 100 into a description of From:the program information distribution server 100/To:the video receiving apparatus 300. Then, the transfer processing unit 102 transfers the changed MESSAGE request to the video receiving apparatus 300.

The video distribution apparatus 200 and the video receiving apparatus 300 can conceal mutually both of their own connection destination information by completely renewing the values of From/To parameter in the Header part.

Moreover, when the program information distribution server 100 transfers the program information, the program information distribution server 100 stores not only the program information itself but also the connection destination information of the video receiving apparatus 300 which is a destination of transferring. This enables the program information distribution server 100, when program information from the video distribution apparatus 200 has been ceased prior to the expiration, to transmit program information including information to notify that program information has ended to the video receiving apparatus 300 which has already transmitted the program information.

### [Confirming Distribution Status]

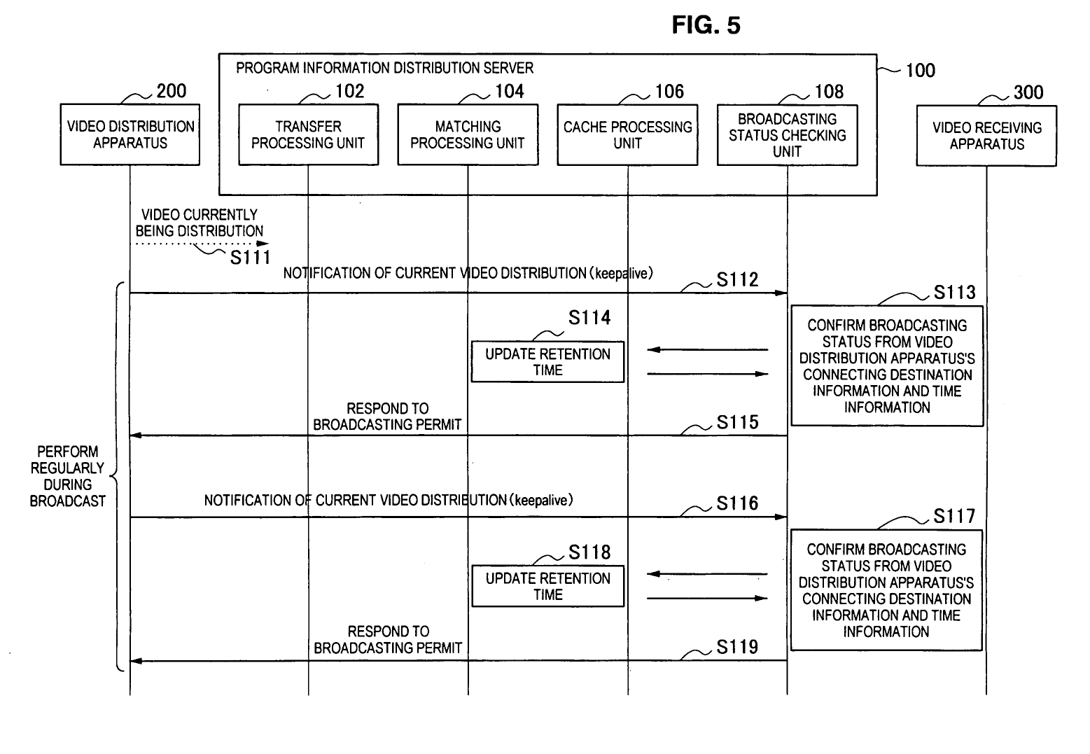

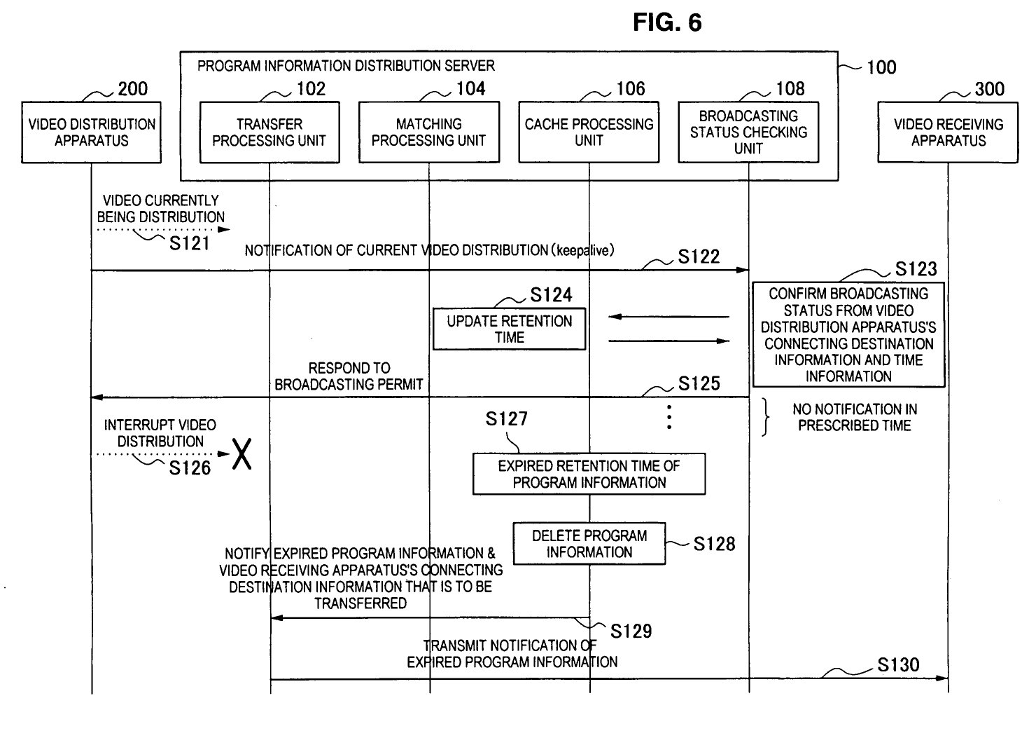

Next, an explanation will be given on an operation in which the program information distribution server 100 according to the present embodiment confirms a state of program distribution from the video distribution apparatus 200. FIG. 5 is a flow chart for illustrating an operation in which the program information distribution system confirms the state of program distribution. FIG. 5 shows a case where a program distribution from the video distribution apparatus 200 has been performed as usual. FIG. 6 is a flow chart for illustrating an operation in which the program information distribution system confirms the state of program distribution. FIG. 6 shows a case where a distribution of a program from the video distribution apparatus 200 has interrupted.

The program information distribution server 100 not only transfers the program information, but confirms the video distribution apparatus 200 whether the movie distribution is actually performed as described in the program information. For example, the video distribution apparatus 200 transmits a KeepAlive notice during distributing the movie, and the program information distribution server 100 receives the KeepAlive notice. As a result, the program information distribution server 100 can determine whether the program information is valid or not. If the KeepAlive notification is not received within a prescribed time range, the program information distribution server 100 determines that the corresponding program information is invalid, and deletes the program information. Moreover, the program information distribution server 100 transmits a MESSAGE request including the program information notifying the program information has ended to the video receiving apparatus 300 to which the program information has been already transferred.

Referring to FIG. 5 and FIG. 6, concrete explanation will be given in the following. At first, as shown in FIG. 5, a program such as a movie or the like is distributing from the video distribution apparatus 200 (step S111). At this time, the video distribution apparatus 200 transmits a KeepAlive notification indicating that the video is currently distributing (step S112). Then, the broadcasting status checking unit 108 of the program information distribution server 100 confirms broadcasting status (distribution status) judging from the connection destination information of the video distribution apparatus 200 and the time information in the program information (step S113). When receiving the KeepAlive notification, the broadcasting status checking unit 108 of the program information distribution server 100 determines that the program information is valid and updates retention time of the program information which has been stored in the cache processing unit 106 (step S114). The program information distribution server 100 notifies the video distribution apparatus 200 of permission for distribution (step S115).

While the video distribution apparatus 200 is distributing video, the above steps from S112 to S115 are repeated. FIG. 5 shows steps S116 to S119 similar to steps S112 to S115. The program information is determined as valid while the video distribution apparatus 200 is distributing video, and the program information is to be stored.

On the other hand, as shown in FIG. 6, there is a case where a process follows from step S121 to S125 same as steps S112 to S115 in FIG. 5, however, after that, the program distribution of video or the like from the video distribution apparatus 200 is interrupted (step S126). In this case, since the program information distribution server 100 stops receiving a KeepAlive notification from the video distribution apparatus 200, after a certain period of time elapsed, the retention time of the program information stored in the cache processing unit 106 will expire (step S127). At this time, the program information distribution server 100 determines that the corresponding program information is invalid, and deletes the program information (step S128).

After that, the cache processing unit 106 notifies the transfer processing unit 102 of the MESSAGE request including the program information notifying the program information has ended (expired), and the connection destination information of the video receiving apparatus 300 which is the destination to where the program information is transferred (step S129). Then, the transfer processing unit 102 transmits the MESSAGE request including the program information notifying the program information has ended (expired) to the video receiving apparatus 300 (step S130).

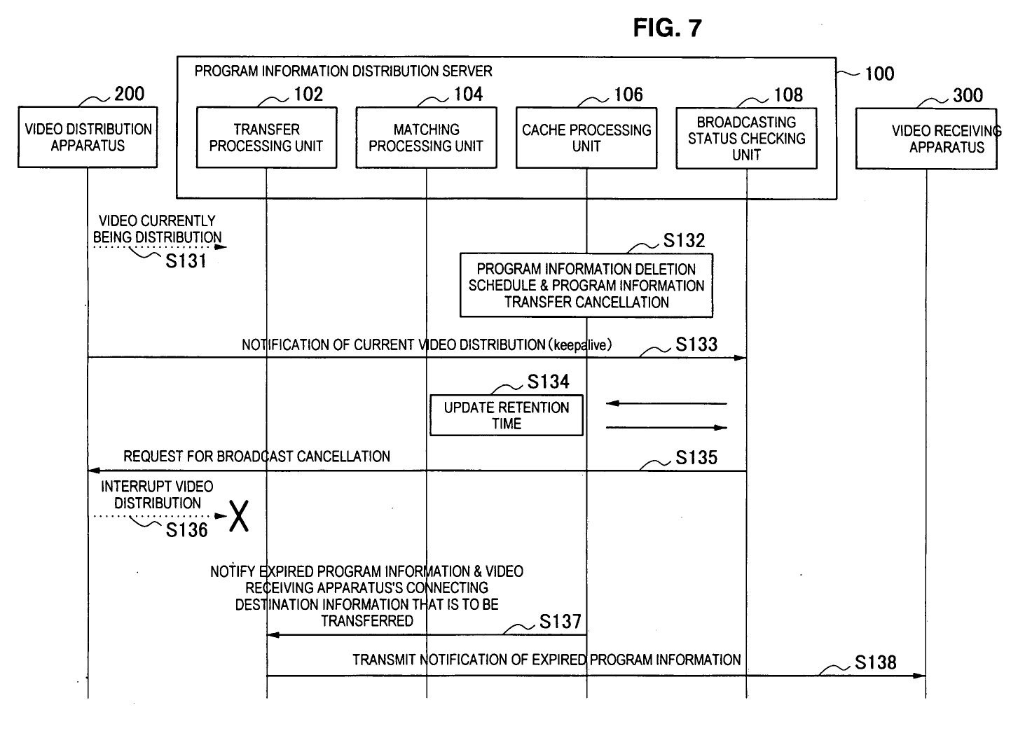

FIG. 7 is a flow chart for illustrating an operation in which the program information distribution system according to the present embodiment confirms a state of program distribution. FIG. 7 shows a case where the program information distribution server 100 requests the video distribution apparatus 200 to cancel the distribution of a program.

In a processing in which the program information distribution server 100 receives a MESSAGE request from the video distribution apparatus 200, a receiving restriction may be applied. For example, the program information distribution server 100 verifies a connection denial list based on the connection source information of the video distribution apparatus 200, and denies receiving from the corresponding video distribution apparatus 200.

Referring to FIG. 7, concrete explanation will be given in the following. At first, as shown in FIG. 7, a program such as a movie or the like is distributing from the video distribution apparatus 200 (step S131). If there is a problem in the content of distribution from the video distribution apparatus 200 or in the distribution of the video distribution apparatus 200, the cache processing unit 106 of the program information distribution server 100 receives an input of a request for scheduling program information deletion or cancelling program information transfer. For example, the program information distribution server 100 verifies the connection denial list based on the connection source information of the video distribution apparatus 200, and if there is the corresponding video distribution apparatus 200 existed, the program information distribution server 100 requests for scheduling program information deletion or cancelling program information transfer (step S132).

When the broadcasting status checking unit 108 of the program information distribution server 100 receives a KeepAlive notification from the video distribution apparatus 200 (step S133), the cache processing unit 106 deletes the program information (step S134). Further, the broadcasting status checking unit 108 requests the video distribution apparatus 200 for broadcast cancellation (step S135).

After receiving the request for broadcast cancellation, the video distribution apparatus 200 discontinues the distribution of the program such as a video from the video distribution apparatus 200 (step S136). After that, the cache processing unit 106 notifies the transfer processing unit 102 of the MESSAGE request including the program information notifying that the program information has ended (expired), and the connection destination information of the video receiving apparatus 300 that is a destination to which the program information is transferred (step S137). Then, the transfer processing unit 102 transmits the MESSAGE request including the program information notifying that the program information has ended (expired) to the video receiving apparatus 300 (step S138).

As described above, according to the present embodiment, the video receiving apparatus 300 can update and display the content of the program information on notice from the program information distribution server 100, and the viewer can refer to the program information that is to be provided in real time.

In the present embodiment, the program information distribution server 100 does not manage the program information, but performs only a process of transferring what the video distribution apparatus 200 has transmitted in accordance with keywords. Therefore, even in a system having a plurality of video distributors, it is not necessary to regenerate the program information every time it is updated. Moreover, since the system becomes a PUSH-type service in which a MESSAGE request is to be received from the program information distribution server 100 at the time of updating, the video receiving apparatus 300 that the viewer holds can also update the program information ensuring the real time capability.

Further, the program information distribution server 100 adds the program information into the body part of the MESSAGE request of SIP, and transmits the MESSAGE request. In consequence, the video distribution apparatus 200, on the distributer side, transmits the program information in real time, and the video receiving apparatus 300, on the viewer side, receives the transmitted program information in real time. The MESSAGE request that the video receiving apparatus 300 on the viewer side receives as program information will be provided by being routed through the program information distribution server 100. This does not mean that the video distribution apparatus 200 transmits to a plurality of receivers. The video distribution apparatus 200 is expected to transmit the MESSAGE request to the program information distribution server 100 only once. In other words, the system can be realized where the program information distribution server 100 copies the MESSAGE request and transmits the MESSAGE request to the video receiving apparatus 300 that has been registered in advance.

Further, by being routed through the program information distribution server 100, it can be possible to decrease the load of the video distribution apparatus 200, and to hide the connection destination information between the video distribution apparatus 200 and the video receiving apparatus 300. In consequence, the program information distribution server 100 does not need to generate individually the program information under the circumstance where there is an unspecified number of video distributors, and it can be possible to decrease the processes and to provide the program information in real time to the viewer.

Further, according to the present embodiment, by transmitting the program information from a plurality of the video distribution apparatuses 200, it can deal with an abnormal circumstance where there is program information that the actual video is not broadcasted existed among the plurality of the program information. In other words, the program information distribution server 100 holds the distribution time based on the program information that is transmitted by the video distribution apparatus 200, and the video distribution apparatus 200 transmits regularly the KeepAlive notification to the program information distribution server 100 while broadcasting. Making such an arrangement enables the program information distribution server 100 according to the present embodiment to manage the broadcasting status. Moreover, when wishing to discontinue broadcast from the corresponding video distribution apparatus 200 or to delete the program information, for some reasons, it can be possible to transmit a request for broadcast cancellation in a response to a KeepAlive notification as well as to delete the program information. Subsequently, the side of the program information distribution server 100 also can manage the state of unspecified number of the video distribution apparatuses 200.

A preferred embodiment of the present invention has been explained in detail above with reference to the attached drawings, the present invention is not limited to this example. It should be understood by those skilled in the art that various modifications, combinations, sub-combinations and alterations may occur depending on design requirements and other factors insofar as they are within the scope of the appended claims or the equivalents thereof.

For example, the above described embodiment uses the NGN to apply to the platform using the MESSAGE request of SIP, however, the present invention is not limited to this example. For example, when developing on the internet, it may be used a communication platform, such as NGN capable of being replaced with the MESSAGE request of SIP and capable of performing name solution for the other communicating party. Consequently, an arrangement similar to the above embodiment can be provided, which uses a program information distribution server, a video distribution apparatus, and a video receiving apparatus.

The present application contains subject matter related to that disclosed in Japanese Priority Patent Application JP 2009-265393 filed in the Japan Patent Office on Nov. 20, 2009, the entire content of which is hereby incorporated by reference.

What is claimed is:

1. A program information distribution apparatus comprising:
a character information receiving unit for receiving desired character information as a predetermined transmitting destination from a program receiving apparatus having a character information transmitting unit that transmits the desired character information related to a program desired to be received;
a program information receiving unit for receiving scheduled program information as a predetermined transmitting destination from a program distributing apparatus having a program information transmitting unit that transmits the scheduled program information related to a program scheduled to be distributed in a certain time slot;
a matching processing unit for determining whether the scheduled program information includes the desired character information by comparison between the desired character information and the scheduled program information; and
a program information transferring unit for transferring the scheduled program information including the desired character information to the program receiving apparatus if determined that the desired character information is included in the scheduled program information.

2. The program information distribution apparatus according to claim 1, further comprising:
a first connection destination information storage unit for holding first connection destination information that identifies the program receiving apparatus,
wherein the program information transmitting unit transmits the scheduled program information to the program receiving apparatus based on the first connection destination information.

3. The program information distribution apparatus according to claim 1, further comprising:
a program information storage unit for holding the scheduled program information including information related to distribution time of the program;
a second connection destination information storage unit for holding second connection destination information that identifies the program distributing apparatus; and
a distribution state checking unit for confirming whether the program has been distributed from the program distributing apparatus in the distribution time of the program based on the second connection destination information.

4. The program information distribution apparatus according to claim 3,
wherein, if confirmed that the program has not been distributed from the program distributing apparatus in the distribution time, the program information transmitting unit transmits a notification indicating that the scheduled program information is invalid to the program receiving apparatus based on the first connection destination information.

5. The program information distribution apparatus according to claim 3,
wherein, if confirmed that the program has not been distributed from the program distributing apparatus in the distribution time, the program information storage unit deletes the scheduled program information that is held.

6. The program information distribution apparatus according to claim 3,
wherein the distribution state checking unit confirms a content of the program distributed from the program distributing apparatus in the distribution time, and
wherein the distribution state checking unit requests the program distributing apparatus to cancel the distribution of the program in accordance with the content of the program.

7. The program information distribution apparatus according to claim 1, further comprising:
the program information storage unit that holds the scheduled program information,
wherein the matching processing unit determines whether the scheduled program information includes the desired character information by comparison between the desired character information and the scheduled program information that is stored; and
wherein the program information transferring unit transfers the scheduled program information including the desired character information to the program receiving apparatus if determined that the desired character information is included in the scheduled program information that is stored.

8. A program information distribution method comprising the steps of:
receiving, by a character information receiving unit, desired character information as a predetermined transmitting destination from a program receiving apparatus having a character information transmitting unit that transmits the desired character information related to a program desired to be received;
receiving, by a program information receiving unit, scheduled program information as a predetermined transmitting destination from a program distributing apparatus having a program information transmitting unit that transmits the scheduled program information related to a program scheduled to be distributed in a certain time slot;
determining, by a matching processing unit, whether the scheduled program information includes the desired character information by comparison between the desired character information and the scheduled program information; and
transferring, by a program information transferring unit, the scheduled program information including the desired character information to the program receiving apparatus if determined that the desired character information is included in the scheduled program information.

9. A program causing a computer to function as:
a receiving unit for receiving desired character information as a predetermined transmitting destination from a program receiving apparatus having a character information transmitting unit that transmits the desired character information related to a program desired to be received;
a receiving unit for receiving scheduled program information as a predetermined transmitting destination from a program distributing apparatus having a program information transmitting unit that transmits the scheduled program information related to a program scheduled to be distributed in a certain time slot;
a determining unit for determining whether the scheduled program information includes the desired character information by comparison between the desired character information and the scheduled program information; and
a transferring unit for transferring the scheduled program information including the desired character information to the program receiving apparatus if determined that the desired character information is included in the scheduled program information.

10. A program information distribution system comprising:
a program receiving apparatus having a character information transmitting unit that transmits desired character information related to a program desired to be received to a predetermined transmitting destination;
a program distributing apparatus having a program information transmitting unit that transmits scheduled program information related to a program scheduled to be distributed in a certain time slot to a predetermined transmitting destination; and
a program information distribution apparatus including:
a character information receiving unit for receiving the desired character information as the predetermined transmitting destination from the program receiving apparatus;
a program information receiving unit for receiving the scheduled program information as the predetermined transmitting destination from the program distributing apparatus;
a matching processing unit for determining whether the scheduled program information includes the desired character information by comparison between the desired character information and the scheduled program information; and
a program information transferring unit for transferring the scheduled program information including the desired character information to the program receiving apparatus if determined that the desired character information is included in the scheduled program information.
